(19) United States
(12) Patent Application Publication
(10) Pub. No.: US 2004/0243555 A1
(43) Pub. Date: Dec. 2, 2004

(54) Methods and systems for optimizing queries through dynamic and autonomous database schema analysis

(75) Inventors: Roger Bolsius, Pleasanton, CA (US); Kevin Malaney, San Francisco, CA (US)

Correspondence Address: YOUNG LAW FIRM, A PROFESSIONAL CORPORATION, 4370 ALPINE ROAD SUITE 106, PORTOLA VALLEY, CA, 94028

(73) Assignee: Oracle International Corp., Redwood Shores, CA

(21) Appl. No.: 10/448,962

(22) Filed: May 30, 2003

(51) Int. Cl. G06F 7/00

(52) U.S. Cl. 707/3

(57) ABSTRACT

A method of optimizing an execution of a query on data may include steps of creating schema object(s) in a database schema, enable monitoring of the schema object(s) to monitor the amount of change of a predetermined characteristic of the schema object(s) over time and loading the data into the created schema object(s). It is then determined whether the amount of change of the predetermined characteristic exceeds a selectable threshold. Updated statistical information may be obtained only when the amount of change exceeds the threshold. The updated statistical information may then be provided to a query execution optimizer, which selects an execution plan based upon the updated statistical information when the amount of change exceeds the threshold or based upon previously provided statistical information when the amount of change does not exceed the threshold. The query may then be executed using the selected execution plan.

### BACKGROUND OF THE INVENTION

1. Field of the Invention

The present invention relates to the field of databases. In particular, the present invention relates to methods and systems for optimizing queries (such as SQL queries) through automatic database schema analysis.

2. Description of the Related Art

The concepts of launching a Web browser, pointing it at a Web site of interest, and viewing the site's content by clicking on the links that are presented on each page are now familiar concepts. A Web page may appear to be a monolithic logical unit when it is viewed, yet it really can be further decomposed. For example, a typical Web page may include some HTML text and multiple images. Other pages may contain running applets that provide streaming audio or video. At other times, the user is not viewing a page in the ordinary sense at all, but may be interacting instead with an application that is running on a server somewhere. The Web server that provides such content may not have the logical concept of a page. From the Web server's point of view, it is merely responding to requests from browsers that connect to it, including requests for HTML text, images, Java Server Pages (JSP) and the like. Web servers usually maintain logs of all such received requests. These log files, therefore, constitute an audit trail that provides detailed information about the activities on a site. This trail is sometimes referred to as the “clickstream” of the site. Every time someone views a page from a Web site, the Web server writes one or more entries in the log file. Moreover, every page view recorded in a Web server log file may correspond to a separate entry therein. The attributes that may be stored in the Web log file may include, for example, measures such as the byte count, dwell time, time to serve, and dimension table foreign keys. The data in the log file usually adheres to one of the standard log file formats unless the format has been customized. Most Web servers support at least one of three open log file formats: NCSA Common Log File Format (CLF), NCSA Extended Log File Format (ECLF), or W3C Extended Log File Format (ExLF).

Because even simple pages typically require multiple requests before they can be fully rendered, Web server log files can quickly grow very large. For example, a small site with only a few hundred page views a day can easily generate log files with thousands of records on a daily basis. A large and popular site may generate a log file in which millions of additional records are added every day. In the early days of the Web, when there was not much activity, it might have been possible for an administrator to manually inspect the log files and gain some rough understanding of the magnitude and nature of the traffic on a Web site. The sheer size and complexity of the log files in use today preclude such an approach. Today's log file volumes require automated methods of turning the raw log file data into useful business information.

Whatever the format, the Web server log file may be used as the raw data to generate various reports related to the Web site's effectiveness, traffic patterns and other usage and performance metrics. Conventional Web analytic applications may have a set of predetermined report engines that query the Web server log file and build a report based upon the results of the queries. However, as such conventional tools do not persistently store the Web log raw data, they do not have the ability to execute ad-hoc and dynamic queries (e.g., SQL queries) of the log file data. Such queries must be formulated within the context of a new report, which will then go back to the Web server log file to execute the queries necessary to build the requested report.

Due to the rapidly changing nature of such logs, such queries may not execute as efficiently as they otherwise might, since the database management system may not have accurate information concerning the current state of the Web server logs. However, gathering such information (for example, the number of rows in a table or partition) is time consuming and burdensome for the database administrator. Consequently, this information may not be gathered in a timely manner, which in turn degrades the performance of the execution of the query and may result in the utilization of greater system resources than would otherwise be required had the information been current.

From the foregoing, it is apparent that methods and systems for gathering timely information regarding the data in the Web server log files are needed. What are needed, moreover, are methods and systems for dynamically and autonomously updating such information to enable a more efficient execution of queries. Preferably, such methods and systems should update the gathered information in an adaptive fashion and should not impose an undue burden upon the database administrator.

### SUMMARY OF THE INVENTION

According to an embodiment thereof, the present invention may be a method of optimizing an execution of a query on data, including the steps of creating a schema object in a database schema; enabling monitoring of the schema object to monitor an amount of change of a predetermined characteristic of the schema object over time; loading the data into the created schema object; determining whether the amount of change of the predetermined characteristic in the monitored object exceeds a selectable threshold; obtaining updated statistical information on the monitored object only when the amount of change exceeds the threshold; providing the updated statistical information to a query execution optimizer, the query execution optimizer selecting one of a plurality of execution plans based upon the updated statistical information when the amount of change exceeds the threshold or based upon statistical information previously provided to the query execution optimizer when the amount of change does not exceed the threshold, and executing the query using the execution plan selected by the query execution optimizer.

The schema object(s) may include a database table, a partition of a database table, an index and/or an index partition, for example. The predetermined characteristic of the monitored object may be selected from a group including number of rows, number of blocks, average row length, number of distinct values in column, number of nulls in column, data distribution in column, number of leaf blocks, levels or clustering factor, for example. The threshold may be selected to be at least about a 2% change in the selected predetermined characteristic. The updated statistical information may include updated partition statistical information from the partition and/or updated global table statistical information from a table to which the partition belongs. The query execution optimizer in the providing step may be a cost based optimizer (CBO), for example. The selected predetermined characteristic may include a number of rows in the monitored schema object and the threshold may be selected to be at least about a 10% change in the number of rows. The amount of change of the predetermined characteristic may be determined cumulatively over time and the updated statistical information may be obtained when a sum of cumulative changes in the predetermined characteristic over time exceeds the threshold. The selectable threshold may be a percentage of change, for example. The data in the loading step may include data from a Web server log file, for example.

According to another embodiment thereof, the present invention is a machine-readable medium having data stored thereon representing sequences of instructions which, when executed by computing device, causes said computing device to optimize an execution of a query on data, by performing the steps of creating a schema object in a database schema; enable monitoring of the schema object to monitor an amount of change of a predetermined characteristic of the schema object over time; loading the data into the created schema object; determining whether the amount of change of the predetermined characteristic in the monitored object exceeds a selectable threshold; obtaining updated statistical information on the monitored object only when the amount of change exceeds the threshold; providing the updated statistical information to a query execution optimizer, the query execution optimizer selecting one of a plurality of execution plans based upon the updated statistical information when the amount of change exceeds the threshold or based upon statistical information previously provided to the query execution optimizer when the amount of change does not exceed the threshold, and executing the query using the execution plan selected by the query execution optimizer.

The schema object(s) may include a database table, a partition of a database table, an index and/or an index partition, for example. The predetermined characteristic of the monitored object may be selected from a group including number of rows, number of blocks, average row length, number of distinct values in column, number of nulls in column, data distribution in column, number of leaf blocks, levels and clustering factor, for example. The threshold may be selected to be at least about a 2% change in the selected predetermined characteristic, for example. The updated statistical information may include updated partition statistical information from the partition and updated global table statistical information from a table to which the partition belongs. The query execution optimizer in the providing step may be a cost based optimizer (CBO), for example. The selected predetermined characteristic may include a number of rows in the monitored object and the threshold may be selected to be at least about a 10% change in the number of rows, for example. The amount of change of the predetermined characteristic may be determined cumulatively over time and the updated statistical information may be obtained when a sum of cumulative changes in the predetermined characteristic over time exceeds the threshold. The selectable threshold may be a percentage of change, for example. The data in the loading step may include data from a Web server log file, for example.

The present invention may also be viewed, according to another embodiment thereof, as a computer system suitable for optimizing an execution of a query on data, comprising a database for storing a plurality of database objects; at least one processor; at least one data storage device; a plurality of processes spawned by said at least one processor, the processes including processing logic for: creating a schema object in a database schema; enable monitoring of the schema object to monitor an amount of change of a predetermined characteristic of the schema object over time; loading the data into the created schema object; determining whether the amount of change of the predetermined characteristic in the monitored object exceeds a selectable threshold; obtaining updated statistical information on the monitored object only when the amount of change exceeds the threshold; providing the updated statistical information to a query execution optimizer, the query execution optimizer selecting one of a plurality of execution plans based upon the updated statistical information when the amount of change exceeds the threshold or based upon statistical information previously provided to the query execution optimizer when the amount of change does not exceed the threshold, and executing the query using the execution plan selected by the query execution optimizer.

The present invention is also a method of collecting statistical information on Web server log data, the method comprising the steps of creating a schema object in a database schema; enable monitoring of the schema object to monitor an amount of change of a number of rows of the schema object over time; loading the log data into the created schema object; determining whether the amount of change in a number of rows in the monitored schema objects over time exceeds a selectable threshold, and obtaining updated statistical information on the monitored schema objects only when the amount of change exceeds the threshold.

The schema object(s) may include a database table, a partition of a database table, an index and/or an index partition, for example. For example, the threshold may be selected to be at least about a 2% change in the number of rows. The updated statistical information may include updated partition statistical information from the partition and updated global table statistical information from a table to which the partition belongs. The amount of change in the number of rows may be determined cumulatively over time and the updated statistical information may be obtained when a sum of cumulative changes in the number of rows over time exceeds the threshold. The selectable threshold may be a percentage of change, for example.

The present invention, according to yet another embodiment thereof, may be a machine-readable medium having data stored thereon representing sequences of instructions which, when executed by computing device, causes said computing device to collect statistical information on Web server log data, by performing the steps of: creating a schema object in a database schema; enable monitoring of the schema object to monitor an amount of change of a number of rows of the schema object over time; loading the log data into the created schema object; determining whether the amount of change in a number of rows in the monitored schema object over time exceeds a selectable threshold, and obtaining updated statistical information on the monitored schema object only when the amount of change exceeds the threshold.

According to still another embodiment thereof, the present invention is a computer system suitable for collecting statistical information on Web server log data, comprising: a database for storing the database objects; at least one processor; at least one data storage device; a plurality of processes spawned by said at least one processor, the processes including processing logic for: creating a schema object in a database schema; enable monitoring of the schema object to monitor an amount of change of a number of rows of the schema object over time; loading the log data into the created schema object; determining whether the amount of change in a number of rows in the monitored schema object over time exceeds a selectable threshold, and obtaining updated statistical information on the monitored schema object only when the amount of change exceeds the threshold.

### BRIEF DESCRIPTION OF THE DRAWINGS

For a further understanding of the objects and advantages of the present invention reference should be made to the following detailed description, taken in conjunction with the accompanying figures, in which:

FIG. 1 shows a table that describes exemplary fields in a Web server log file.

FIG. 2 is a flowchart of a method of optimizing a query on data, according to an embodiment of the present invention.

FIG. 3 is a flowchart of a method of collecting statistical information on data loaded into schema objects, according to an embodiment of the present invention.

FIG. 4 illustrates a block diagram of a computer system within which an embodiment of the present invention may be implemented.

### DESCRIPTION OF THE PREFERRED EMBODIMENTS

### Definitions

Database: A collection of data treated as a unit. The general purpose of a database is to store and retrieve related information. A database has logical structures and physical structures.

Schema: A schema is a collection of objects. A schema may be associated with each database user. Schema objects are the logical structures that directly refer to the database's data. Schema objects include such structures as tables, views, sequences, stored procedures, synonyms, indexes, clusters and database links.

Table: A table is a basic unit of storage in a database. Data in tables is stored in rows and columns. A row is a collection of column information corresponding to a single record.

Partitioning: Partitioning addresses the key problem of supporting large tables and indexes by allowing users to decompose them into smaller and more manageable pieces called partitions. Partitioning improves many performance characteristics, including the loading, querying and maintaining of large database tables. Range partitioning maps rows of a table to partitions based on ranges of column values.

SQL: Structured Query Language, a cross platform language used to select, update, insert, or delete data in relational databases. SQL is also used to administer the relational database management system (RDBMS).

Index. Indices are structures that are with tables and views that speed retrieval of rows.

### Functional Overview

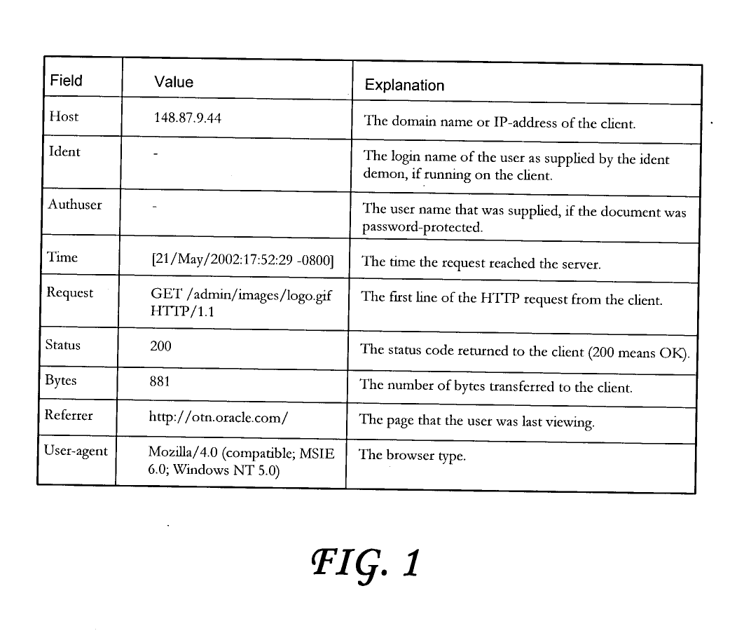

FIG. 1 shows a table that describes the meaning of exemplary fields in a Web server log file. As shown therein, a Web server log file may include a host field, which identifies the domain name or IP-address of the computer accessing the Web site. Other fields may include the date and time at which the HTTP request reached the Web server, an identification of the page the user was viewing and the browser type. The Web server log may include many other fields, some of which are shown in FIG. 1. Each time a user accesses the Web server and makes an HTTP request, an entry may be created in the Web server log file. Understandably, popular Web sites may receive millions of such HTTP requests every day. According to an embodiment of the present invention, the raw data from the Web server log file may be loaded into a database schema in the form of database tables. As the raw data is stored in a database schema, the entire Web server log file may be freely queried using any standard SQL tool, for example. To optimize the query performance, the table or tables that contain the Web server log data and that are loaded of the schema may be partitioned. Such partitioning may not only increase the query performance, but may also reduce the time required to rebuild indices, among other benefits.

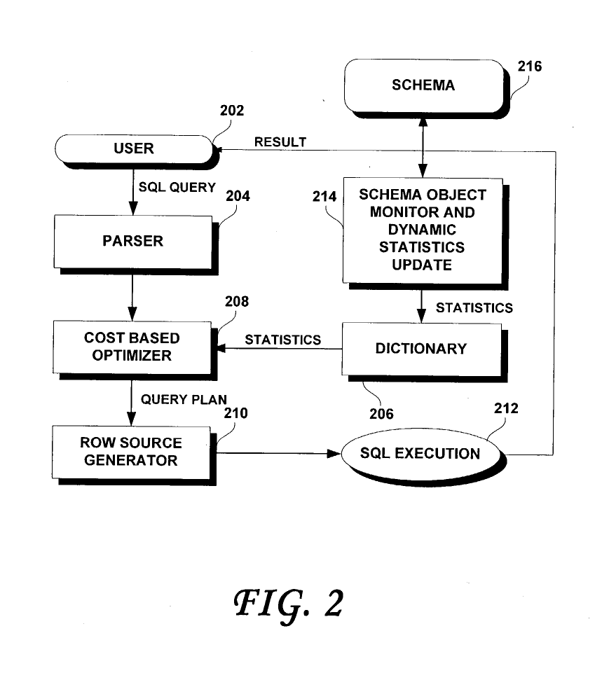

Such queries may be carried out by causing the execution of one or more SQL (for example) statements or set of SQL statements, to build a report, for example. However, SQL statements may be executed in a variety of ways. Some of these ways may be more efficient than others and/or may consume fewer systems resources, for example. As shown in FIG. 2, to process an SQL statement, a user 202 issues a query containing an SQL statement. A parser 204 receives this SQL statement and checks the syntax of the statement and performs a semantic analysis thereon. Thereafter, the SQL statement may be passed to an optimizer 208, which may determine the most efficient way to execute and produce the result of the query. The optimizer 208 may be or include a rule-based optimizer (RBO), a semantic optimizer and/or or a cost-based optimizer (CBO), for example.

The statistical information gathered on the schema object or objects is stored in a dictionary 206, which provides the statistical information to the optimizer 208. A row source generator 210 then receives the optimal plan from the optimizer 208 and outputs the execution plan for the SQL statement to a SQL execution engine that operates on the chosen execution plan to execute the SQL statement, as shown at 212. The result of the execution of the SQL statement is then passed back to the user 202.

The optimizer 208 determines the most efficient way to execute the SQL statement after considering many factors related to the schema objects referenced and the conditions specified in the query. The determination of the execution plan by the optimizer 208 is an important step in the processing of any SQL statement and can greatly affect execution time. To perform cost-based optimization, the optimizer 208 requires specific information about the stored data. In turn, to retrieve the required information as efficiently as possible, the cost-based optimizer 208 uses statistics derived from the underlying schema objects to estimate the cost of carrying out the query in terms of, for example, physical disk I/O, among other factors. Using these statistics, stored in the dictionary 206, the cost-based optimizer 208 then arrives at an execution plan that has the lowest estimated cost in terms of system overhead and resources. Specifically, the cost-based optimization approach may utilize these statistics to calculate the selectivity of predicates and to estimate the cost of each execution plan. Selectivity is the fraction of rows in a table that the SQL statement's predicate chooses. The optimizer uses the selectivity of a predicate to estimate the cost of a particular access method and to determine the optimal join order and join method, for example.

To insure that the optimizer 208 arrives at cost estimates that accurately reflect the current state of the data referenced by the schema objects, the statistical information must be maintained current, or the optimizer 208 may not output the optimal execution plan, or even a reasonably efficient execution plan. Embodiments of the present invention do not impose the duty to maintain this statistical information current upon the database administrator. Such a burden is much greater in the case wherein the data on which the statistics are gathered is dynamic and changes frequently, as is the case with data derived from Web server log files, for example. When the statistics are stale (i.e., do not adequately reflect the current state of the data), the optimizer may not select the lowest (or a reasonably low) cost execution plan and the resultant execution of the SQL query may utilize greater system resources and take longer to complete than would otherwise have been the case had the statistic been maintained current with the changing data. According to embodiments of the present invention, statistics may be gathered periodically for schema objects for which the statistics become stale over time because of changing data volumes (e.g., number of rows) or changes in column values. The gathering of the statistics on the monitored schema objects may be timed at regular intervals. However, to avoid gathering statistics on schema objects that have not changed since the time statistics were gathered or only changed in a non-statistically significant manner, the statistics may be gathered only when the monitored schema objects are determined to have changed in a manner that is likely to affect the execution plan chosen by the optimizer 208. Accordingly, other embodiments of the present invention monitor selected schema object or objects (e.g., the Web server log data loaded into the schema 216) and dynamically and autonomously gather statistical information thereon when a predetermined condition is satisfied, such as when a selectable change threshold is reached, as indicated in FIG. 2 at 214. The updated statistics on the monitored schema object or objects may then be fed to the dictionary 206.

The selectable change threshold may be set such that new statistics on the schema object's data or structure are gathered after the schema object's data or structure are modified in ways that would make the previous statistics inaccurate and/or cause the optimizer to select a sub-optimal execution plan for the SQL statement or statements of the query. For example, after loading a significant number of rows into a table, embodiments of the present invention may cause the collection of new statistics on the schema object, a partition or sub-partition thereof. These new statistics may then be stored in the dictionary 206, as shown in FIG. 2. After the data in a table is updated, new statistics on the number of rows may not need to be collected. However, new statistics on the average row length may be gathered and provided to the optimizer.

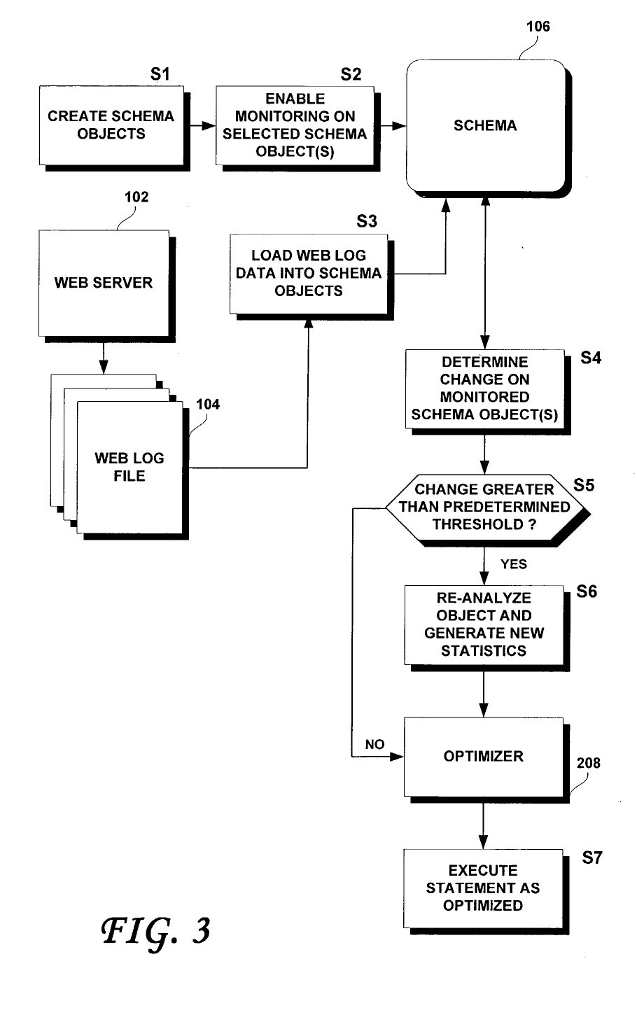

FIG. 3 is a flowchart of a method of optimizing a query on data, such as Web server log data, for example. As shown, step S1 calls for the creation of schema objects (such as, for example, tables) within schema 106. Monitoring is then enabled on these or selected ones of the created schema objects, as shown at S2. Monitoring tracks the number of INSERTs, UPDATEs, and DELETEs, for example, for the monitored schema object(s) since the last time statistics were gathered. Monitoring selected schema objects (e.g., as triggered by INSERTS, UPDATES and DELETEs) avoids the overhead associated with gathering statistics on all tables or other schema objects at one time. This information may then be used to identify tables or other schema objects with stale or no statistics. Therefore, the changes on the monitored schema objects determine the timing of the updates on the statistics on the monitored schema objects. The data written to the Web log files 104 by server 102 may then be loaded into the created schema objects, as suggested at S3. Step S4 calls for the determination of the change on the monitored schema object or objects. For example, the determination in step S4 may determine the change in the number of rows in the monitored schema objects. In step S5, it is determined whether the change in the monitored schema object or objects is greater than a predetermined (and selectable) change threshold. For example, the change threshold may be set at whatever level would affect the query execution plan selected by the optimizer 208. For example, the change threshold may be set at about 2%. That is, when the amount of change of the predetermined characteristic in the monitored object exceeds the threshold of 2%, updated statistical information on the monitored schema object or objects may be obtained. According to an embodiment of the present invention, the predetermined characteristic of the monitored schema object is the number of rows. That is, when the number of rows in the monitored schema object or objects exceeds the change threshold of 2%, the monitored schema objects may be analyzed and new statistics gathered thereon and provided to the dictionary 206. According to an embodiment of the present invention, the predetermined characteristic is the number of rows and the change threshold is set at 10%, although other changes in characteristics other than the number of rows may be monitored and other change thresholds may be selected within the context of the present invention. The frequency of collection intervals (and thus the magnitude of the change threshold) should balance the task of providing accurate statistics for the optimizer 208 against the processing and resource utilization overhead incurred by the statistics collection process or processes. According to an embodiment of the present invention, the monitoring of the selected schema objects may track the changes in the monitored schema objects in a cumulative fashion. That is, small incremental changes in the monitored schema object or objects may be added together until the predetermined change threshold is exceed, at which point new statistics for the monitored object or objects may be gathered. As shown in the “NO” branch of step S5, if the predetermined characteristic of the monitored schema objects have not changed more than the predetermined change threshold (e.g., if the number of rows has not changed by a cumulative amount greater than about 10%, for example), the previously gathered statistics stored in the dictionary 206 are used by the optimizer 208 in selecting the execution plan for the (e.g., SQL statement or statements of the) user's query. As shown by the “YES” branch of step S5, if the change is greater than the predetermined change threshold, the monitored object or objects (all of them or only those monitored schema objects that exhibited the change greater than the predetermined change threshold) may be re-analyzed as shown at S6 and new and updated statistics may be gathered thereon and provided to the dictionary 206, replacing any older statistics on the corresponding monitored schema object or objects. In turn, the updated statistics may be utilized by the (cost-based, for example) optimizer 208, which then selects a suitably low cost execution plan for the query. As shown in step S7, the query may then be executed according to the execution plan selected by the optimizer 208 and the result of the query provided to the requesting user and/or process.

When new statistics are gathered for a monitored schema object such as a table, column, or index, if the data dictionary 206 already contains statistics for the object, then the new statistics replace the existing statistics. Moreover, any currently parsed (e.g., SQL) statements that access the object may be invalidated. The next time such a statement executes, the optimizer 208 may automatically choose a new execution plan based on the new updated statistics. Moreover, distributed statements issued on remote databases that access the monitored schema objects may make use of the new updated statistics the next time they are parsed.

Multiple sets of statistics may be gathered for partitioned schema objects. Indeed, partitioned objects (such as partitioned tables, for example), may generate statistics that refer to any of the following:

The entire partitioned object as a whole (global statistics);

An individual partition, and/or

An individual sub-partition of a composite partitioned object.

According to an embodiment of the present invention, unless the query predicate narrows the query to a single partition of the partitioned object within the schema 106, the optimizer 208 may utilize the global statistics (i.e., the statistics gathered for the entire partitioned object, as opposed to one or more partitions or sub-partitions thereof). Because most queries are not likely to be this restrictive, it is most important to have accurate global statistics. Even for restrictive queries, it is important to have global statistics because the optimizer must choose between execution plans that access individual partitions and plans that operate on the entire table as a whole.

According to another embodiment of the present invention, the monitored schema object may be a single partition or a set of partitions. To determine when to obtain new statistics for a partition and/or global statistics (i.e., statistics for the entire partitioned object), the following determination may be made. According to an embodiment of the present invention, if the ratio of the sum of the number of rows (or other predetermined characteristic) in all of the partitions of the monitored partitioned object (as obtained from currently gathered statistics) to the number of rows in the entire partitioned object (e.g., statistics of the entire table, as also obtained from currently gathered statistics) falls outside a selectable threshold range, then new statistics should be gathered, preferably at least on the entire monitored partitioned object. Obtaining new statistics on the entire partitioned object as a whole is desirable, as some queries (e.g., SQL statements) only access one or more partitions, whereas others may access an entire table, index or other schema object. For example, the threshold range may be selected to be from about 0.9 to about 1.1, for example. In this manner, if the ratio of the sum of the number of rows in all partitions to the sum of the rows of the entire partitioned object is greater than 1.1 or less than 0.9 (in effect, a 10% change), then new statistics may be gathered, provided to and stored within the dictionary 206. It is understood that the threshold range may be narrowed or expanded as appropriate. Doing so will lessen and increase, respectively, the burden and frequency of gathering the statistics on the monitored schema objects.

The following is an exemplary process for determining whether to gather new statistics on a partitioned object such as a table, according to an embodiment of the present invention. Given a table T partitioned into a plurality of partitions P, the following steps may be carried out. At the outset, it is determined whether the dictionary 206 contains any statistics for the partition P or whether the number of changed rows (or other predetermined characteristic) of the partition P is greater than, e.g., 10% of the number of rows from previously gathered statistics. If the dictionary 206 does not contain any statistics for the partition P or if the number of changed rows (i.e., number of rows inserted, updated, or deleted) exceeds 10%, then new partition level statistics are gathered for the partition P under consideration. Thereafter, a variable A may be defined as the sum of the number of rows from current partition statistics of all partitions P in table T. A variable B may also be defined as the number of rows from the current statistics for the entire table T. Thereafter, the decision whether to gather new statistics for the entire table T (global statistics for table T) may be taken as follows. If there are no current statistics for the entire table T or if (B=0 and A≠0) or if (B≠0 and (A/B>1.1 or A/B<0.9)), then gather new global statistics for table T.

### EXAMPLE

Partitions P0, P1, and P2 are created on table T. Initially table T contains 100 rows in partition P0. Global-level and partition-level statistics are gathered for table T. Thereafter, 100 rows are inserted into partition P1. The above-described process according to an embodiment of the present invention may be invoked on table T to determine whether new global statistics should be gathered on this table. New Statistics are gathered for partition P1 since the number of changed rows (100) is greater than 10% of the previous number from statistics (0). Statistics are not gathered again for partitions P0 and partition P2 since there are no changed rows in these partitions. According to the above, variables A and B may be evaluated as follows:

A=100+100+0=200;

B=100;

The ratio A/B=2, which is greater than 1.1. Accordingly, new global statistics may be gathered for table T.

### Hardware Overview

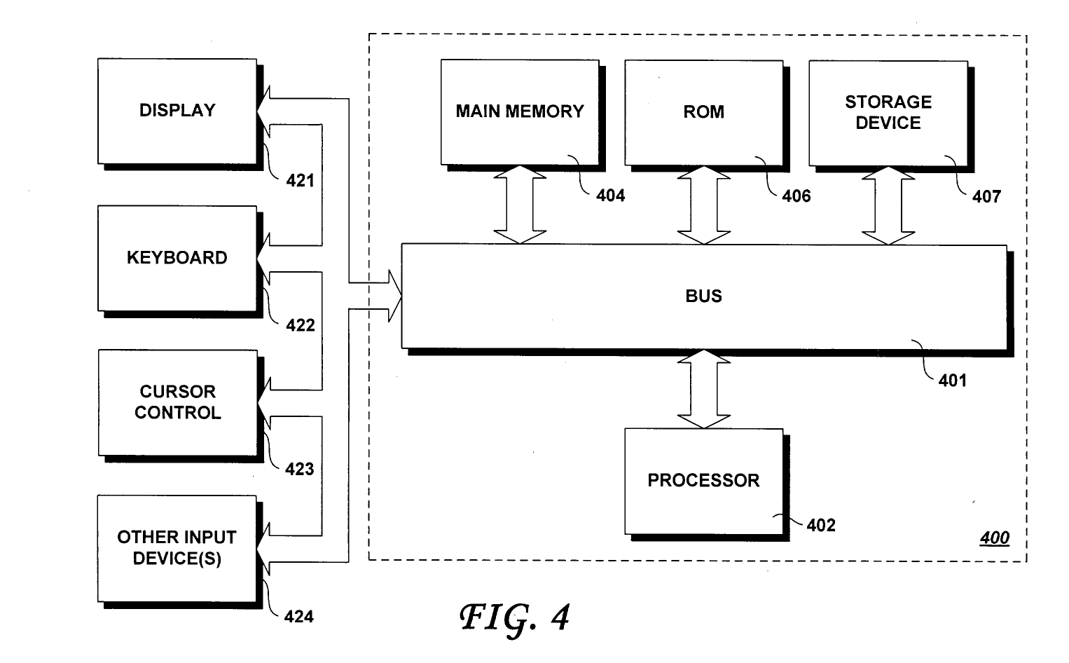

FIG. 4 illustrates a block diagram of a computer system 400 upon which an embodiment of the present invention may be implemented. Computer system 400 includes a bus 401 or other communication mechanism for communicating information, and one or more processors 402 (one shown in FIG. 4) coupled with bus 401 for processing information. Computer system 400 further comprises a random access memory (RAM) or other dynamic storage device 404 (referred to as main memory), coupled to bus 401 for storing information and instructions to be executed by processor(s) 402. Main memory 404 also may be used for storing temporary variables or other intermediate information during execution of instructions by processor 402. Computer system 400 also includes a read only memory (ROM) and/or other static storage device 406 coupled to bus 401 for storing static information and instructions for processor 402. A data storage device 407, such as a magnetic disk or optical disk, is coupled to bus 401 for storing information and instructions.

The computer system 400 may also be coupled via the bus 401 to a display device 421, such as a cathode ray tube (CRT), for displaying information to a computer user. An alphanumeric input device 422, including alphanumeric and other keys, is typically coupled to bus 401 for communicating information and command selections to processor(s) 402. Another type of user input device is cursor control 423, such as a mouse, a trackball, or cursor direction keys for communicating direction information and command selections to processor 402 and for controlling cursor movement on display 421. This input device typically has two degrees of freedom in two axes, a first axis (e.g., x) and a second axis (e.g., y), which allows the device to specify positions in a plane.

Alternatively, other input devices such as a stylus or pen may be used to interact with the display. A displayed object on a computer screen may be selected by using a stylus or pen to touch the displayed object. The computer detects the selection by implementing a touch sensitive screen. Similarly, a light pen and a light sensitive screen may be used for selecting a displayed object. Such devices may thus detect selection position and the selection as a single operation instead of the “point and click,” as in a system incorporating a mouse or trackball. Stylus and pen based input devices as well as touch and light sensitive screens are well known in the art. Such a system may also lack a keyboard such as 422 wherein all interface is provided via the stylus as a writing instrument (like a pen) and the written text is interpreted using optical character recognition (OCR) techniques.

The present invention is related to the use of computer system 400 and/or to a plurality of such computer systems to optimize the execution of (SQL, for example) queries on data (including Web log data, for example). According to one embodiment, the partitioning is provided by one or more computer systems 400 in response to processor(s) 402 executing sequences of instructions contained in memory 404. Such instructions may be read into memory 404 from another computer-readable medium, such as data storage device 407. Execution of the sequences of instructions contained in memory 404 causes processor(s) 402 to perform the process steps that will be described hereafter. In alternative embodiments, hard-wired circuitry may be used in place of or in combination with software instructions to implement the present invention. Thus, the present invention is not limited to any specific combination of hardware circuitry and software.

While the foregoing detailed description has described preferred embodiments of the present invention, it is to be understood that the above description is illustrative only and not limiting of the disclosed invention. Importantly, although the embodiments of the present invention are presented herewith in the context of optimizing queries on Web server log data, it should be apparent that the present invention is not limited thereto. Indeed, embodiments of the present invention are equally and readily applicable to optimizing queries on other types of data loaded into a schema. Moreover, embodiments of the present invention are not limited to the dynamic and autonomous analysis of Web server data, but may be applied to the dynamic and autonomous gathering of statistical information on most any other type of database data. Thus, the present invention should be limited only by the claims as set forth below.

What is claimed is:

1. A method of optimizing an execution of a query on data, comprising the steps of:
creating a schema object in a database schema;
enable monitoring of the schema object to monitor an amount of change of a predetermined characteristic of the schema object over time;
loading the data into the created schema object;
determining whether the amount of change of the predetermined characteristic in the monitored object exceeds a selectable threshold;
obtaining updated statistical information on the monitored object only when the amount of change exceeds the threshold;
providing the updated statistical information to a query execution optimizer, the query execution optimizer selecting one of a plurality of execution plans based upon the updated statistical information when the amount of change exceeds the threshold or based upon statistical information previously provided to the query execution optimizer when the amount of change does not exceed the threshold, and
executing the query using the execution plan selected by the query execution optimizer.

2. The method of claim 1, wherein the schema object includes at least one of a database table, a partition of a database table, an index and an index partition.

3. The method of claim 1, wherein the predetermined characteristic of the monitored object is selected from a group including number of rows, number of blocks, average row length, number of distinct values in column, number of nulls in column, data distribution in column, number of leaf blocks, levels, clustering factor.

4. The method of claim 1, wherein the threshold is selected to be at least about a 2% change in the selected predetermined characteristic.

5. The method of claim 2, wherein the updated statistical information includes at least one of updated partition statistical information from the partition and updated global table statistical information from a table to which the partition belongs.

6. The method of claim 1, wherein the query execution optimizer in the providing step is a cost based optimizer (CBO).

7. The method of claim 1, wherein the selected predetermined characteristic includes a number of rows in the monitored schema object and wherein the threshold is selected to be at least about a 10% change in the number of rows.

8. The method of claim 1, wherein the amount of change of the predetermined characteristic is determined cumulatively over time and wherein the updated statistical information is obtained when a sum of cumulative changes in the predetermined characteristic over time exceeds the threshold.

9. The method of claim 1, wherein the selectable threshold is a percentage of change.

10. The method of claim 1, wherein the data in the loading step includes data from a Web server log file.

11. A machine-readable medium having data stored thereon representing sequences of instructions which, when executed by computing device, causes said computing device to optimize an execution of a query on data, by performing the steps of:
creating a schema object in a database schema;
enable monitoring of the schema object to monitor an amount of change of a predetermined characteristic of the schema object over time;
loading the data into the created schema object;
determining whether the amount of change of the predetermined characteristic in the monitored object exceeds a selectable threshold;
obtaining updated statistical information on the monitored object only when the amount of change exceeds the threshold;
providing the updated statistical information to a query execution optimizer, the query execution optimizer selecting one of a plurality of execution plans based upon the updated statistical information when the amount of change exceeds the threshold or based upon statistical information previously provided to the query execution optimizer when the amount of change does not exceed the threshold, and
executing the query using the execution plan selected by the query execution optimizer.

12. The medium of claim 11, wherein the schema object includes at least one of a database table, a partition of a database table, an index and an index partition.

13. The medium of claim 11, wherein the predetermined characteristic of the monitored object is selected from a group including number of rows, number of blocks, average row length, number of distinct values in column, number of nulls in column, data distribution in column, number of leaf blocks, levels, clustering factor.

14. The medium of claim 11, wherein the threshold is selected to be at least about a 2% change in the selected predetermined characteristic.

15. The medium of claim 12, wherein the updated statistical information includes updated partition statistical information from the partition and updated global table statistical information from a table to which the partition belongs.

16. The medium of claim 11, wherein the query execution optimizer in the providing step is a cost based optimizer (CBO).

17. The medium of claim 11, wherein the selected predetermined characteristic includes a number of rows in the monitored object and wherein the threshold is selected to be at least about a 10% change in the number of rows.

18. The medium of claim 11, wherein the amount of change of the predetermined characteristic is determined cumulatively over time and wherein the updated statistical information is obtained when a sum of cumulative changes in the predetermined characteristic over time exceeds the threshold.

19. The medium of claim 11, wherein the selectable threshold is a percentage of change.

20. The medium of claim 11, wherein the data in the loading step includes data from a Web server log file.

21. A computer system suitable for optimizing an execution of a query on data, comprising:
a database for storing a plurality of database objects;
at least one processor;
at least one data storage device;
a plurality of processes spawned by said at least one processor, the processes including processing logic for:
creating a schema object in a database schema;
enable monitoring of the schema object to monitor an amount of change of a predetermined characteristic of the schema object over time;
loading the data into the created schema object;
determining whether the amount of change of the predetermined characteristic in the monitored object exceeds a selectable threshold;
obtaining updated statistical information on the monitored object only when the amount of change exceeds the threshold;
providing the updated statistical information to a query execution optimizer, the query execution optimizer selecting one of a plurality of execution plans based upon the updated statistical information when the amount of change exceeds the threshold or based upon statistical information previously provided to the query execution optimizer when the amount of change does not exceed the threshold, and
executing the query using the execution plan selected by the query execution optimizer.

22. A method of collecting statistical information on Web server log data, the method comprising the steps of:
creating a schema object in a database schema;
enable monitoring of the schema object to monitor an amount of change of a number of rows of the schema object over time;
loading the log data into the created schema object;
determining whether the amount of change in a number of rows in the monitored schema object over time exceeds a selectable threshold, and
obtaining updated statistical information on the monitored schema object only when the amount of change exceeds the threshold.

23. The method of claim 22, wherein the schema object includes at least one of a database table, a partition of a database table, an index and an index partition.

24. The method of claim 22, wherein the threshold is selected to be at least about a 2% change in the number of rows.

25. The method of claim 23, wherein the updated statistical information includes updated partition statistical information from the partition and updated global table statistical information from a table to which the partition belongs.

26. The method of claim 22, wherein the amount of change in the number of rows is determined cumulatively over time and wherein the updated statistical information is obtained when a sum of cumulative changes in the number of rows over time exceeds the threshold.

27. The method of claim 22, wherein the selectable threshold is a percentage of change.

28. A machine-readable medium having data stored thereon representing sequences of instructions which, when executed by computing device, causes said computing device to collect statistical information on Web server log data, by performing the steps of:
creating a schema object in a database schema;
enable monitoring of the schema object to monitor an amount of change of a number of rows of the schema object over time;
loading the log data into the created schema object;
determining whether the amount of change in a number of rows in the monitored schema object over time exceeds a selectable threshold, and
obtaining updated statistical information on the monitored schema object only when the amount of change exceeds the threshold.

29. The medium of claim 28, wherein the schema object includes at least one of a database table, a partition of a database table, an index and an index partition.

30. The medium of claim 28, wherein the threshold is selected to be at least about a 2% change in the number of rows.

31. The medium of claim 29, wherein the updated statistical information includes updated partition statistical information from the partition and updated global table statistical information from a table to which the partition belongs.

32. The medium of claim 28, wherein the amount of change in the number of rows is determined cumulatively over time and wherein the updated statistical information is obtained when a sum of cumulative changes in the number of rows over time exceeds the threshold.

33. The medium of claim 28, wherein the selectable threshold is a percentage of change.

34. A computer system suitable for collecting statistical information on Web server log data, comprising:
a database for storing the database objects;
at least one processor;
at least one data storage device;
a plurality of processes spawned by said at least one processor, the processes including processing logic for:
creating a schema object in a database schema;
enable monitoring of the schema object to monitor an amount of change of a number of rows of the schema object over time;
loading the log data into the created schema object;
determining whether the amount of change in a number of rows in the monitored schema object over time exceeds a selectable threshold, and
obtaining updated statistical information on the monitored schema object only when the amount of change exceeds the threshold.
